(19) United States
(12) Patent Application Publication
(10) Pub. No.: US 2014/0232027 A1
(43) Pub. Date: Aug. 21, 2014

(54) CONTINUOUS METHOD FOR THE PRODUCTION OF LIGHT GUIDE PLATES

(71) Applicants: Wojciech Pisula, Mainz (DE); Jann Schmidt, Weiterstadt (DE); Gerd Machleid, Bensheim (DE); Alexander Baum, Frankfurt (DE)

(72) Inventors: Wojciech Pisula, Mainz (DE); Jann Schmidt, Weiterstadt (DE); Gerd Machleid, Bensheim (DE); Alexander Baum, Frankfurt (DE)

(73) Assignee: Evonik Roehm GmbH, Darmstadt (DE)

(21) Appl. No.: 14/240,138

(22) PCT Filed: Aug. 21, 2012
(86) PCT No.: PCT/EP2012/066217

§ 371 Date: Feb. 21, 2014

(30) Foreign Application Priority Data
Aug. 23, 2011 (EP) 11178457.5

(51) Int. Cl. B29D 11/00; B23K 26/00

(52) U.S. Cl. CPC B29D 11/00663; B23K 26/0084; B23K 26/0057
USPC 264/1.27

(57) ABSTRACT

The present invention relates to a method for continuously producing light guide plates, e.g. for use as backlighting in LC displays, and to an apparatus for carrying out said method.

The present invention relates to a method for continuously producing light guide plates, e.g. for use as backlighting in LCD displays, and to an apparatus for carrying out said method.

In light guide plates, for the backlighting of LCD displays, light is introduced via the edge of the light guide plate and coupled out via the surface of the plate. In order in this case to achieve a particularly homogeneous or controlled brightness distribution on the surface of the plate, light-influencing structures are required on at least one side of the light guide plate. Said light-influencing structures very often consist of a printed pattern that is imprinted on a surface of the light guide plate. In this case, a dot or line pattern is imprinted such that the density is high in the centre of the plate and falls according to a specific function towards the edges. Such patterns are typically applied to the surface of the plate in the screen printing method. This is disclosed, e.g., in the patent JP4082791A.

What is disadvantageous about the method mentioned above is, inter alia, that each plate can only be printed individually in the screen printing method, which means a relatively high expenditure in respect of manual labour. Each plate is separately placed into the screen printing machine, and subsequently removed from the machine after the printing and drying process and manually provided with a protective film. A further disadvantage of printing methods is the light absorption of the ink owing to the particles and the binder. That adversely affects the efficiency of a light guide plate.

One alternative with respect to producing structures on the surface of the light guide plate is laser engraving (laser ablation). In this case, individual well-defined cavities are introduced into the surface of the plate by a laser pulse, which cavities have a light-scattering effect and thus couple the light out of the plate. Such methods are described in the patents US 20090067178 and US 20060120110. In order to achieve a homogeneous luminance, a corresponding structure pattern is produced in patents mentioned above.

An alternative method is disclosed in KR 2008001775. Here, cavities of different sizes are worked into the back surface of the plate by laser engraving. In this case, the dimension of the light scatterers increases with the distance from the light source. A homogeneous luminance is obtained as a result.

U.S. Pat. No. 6,843,587 likewise describes a method for the laser engraving of light guide plates. In this case, the plate is fixed to a table by vacuum. The pattern is produced by a laser or pivotable mirror moving to the corresponding positions above the light guide in the x-y horizontal plane. This method was extended in patent KR 20060091879A, such that two plates can be structured simultaneously. The pattern is produced here by a movement combination between the plates (y-axis) and the laser head (x-axis). A further modification of this method is claimed in KR 20050104118A, in which it is possible to process 4 plates, wherein said plates are situated on a rotating table and are positioned separately under an x-y laser for structuring. A semi-continuous method is presented in patent US 20070251930, which is based on a rotating table on which the individual light guide plates are placed. The pattern is produced by the rotational movement of the table and the laser head movement perpendicular thereto. As a disadvantage, only circular patterns can be produced on the plate. An improvement in the speed of the laser structuring can also be achieved by splitting the laser beam into a plurality of beams that impinge separately on different regions of the plate. This method is described in patent KR 2008002354.

What is common to all of the methods mentioned above is that they are associated with high manual and/or technical expenditure. In all cases, the light guide plates have to be firstly produced and subsequently introduced into the laser engraving apparatus. After engraving, the plates have to be removed again.

Against the background of the constantly growing market for backlight units for LCD screens, which is under severe price pressure, there is therefore still a great demand for more effective and more cost-effective methods for producing corresponding light guide plates.

Therefore, one object of the present invention was to provide a novel method for producing light guide plates which does not have the disadvantages of the methods of the prior art, or has said disadvantages only to a reduced extent. Furthermore, the intention is to provide an apparatus for carrying out said method.

One particular object is seen in providing a more effective and more economic method. This method is additionally intended to be as flexible as possible with regard to the light guide geometry and the dimensions of the light guide.

In a further specific embodiment, the method according to the invention is intended to be configured in such a way that stress corrosion in the light guide plate and/or the emission of by-products harmful to heath are/is avoided.

Further objects not explicitly mentioned are evident from the overall context of the present description, examples, figures and claims.

The inventors have now surprisingly found that it is possible to achieve the set objects by integrating a laser structuring unit into an apparatus for producing light guide plates, at a location before individual light guides are cut from a continuous plastic web. In this case, the method according to the invention is distinguished by the fact that the plastic web is led continuously past the laser engraving device and individual light guide plates are cut only after engraving. The entire process is thus carried out inline in a machine. The costly insertion of the light guide blanks into a separate laser engraving device is obviated.

Furthermore, the method according to the invention makes it possible to engrave only one or else simultaneously both sides of the light guide plates. This is a further advantage over the methods of the prior art, in which, by virtue of the “conveying tables”, only one side of the light guide plates can ever be engraved.

In one specific embodiment of the present invention, the laser engraving unit is arranged in the apparatus according to the invention in such a way that the plastic web to be engraved still has a corresponding residual heat from the production of the plastic web. This is because the inventors have surprisingly found that stress corrosion in the light guide plate can be avoided by engraving a warm plastic web. In the prior art, e.g. U.S. Pat. No. 6,843,587 B2, although methods in which the light guide plates are heated prior to laser engraving are also described, however, these methods have the disadvantage that an already cooled plate has to be heated anew. Furthermore, the plates in the prior art are heated only from one side, which causes a temperature gradient in the plate. The method according to the invention has for the first time made it possible to feed to laser engraving a plastic web whose temperature is regulated uniformly on both surfaces and thus effectively to prevent stress corrosion.

The plates produced according to the method according to the invention have the advantage that they are mechanically stable over a long time.

Consequently, the present invention relates to a continuous method for producing light guide plates and to an apparatus for carrying out said method as defined in the following description, the examples, drawings and claims.

In particular, the present invention relates to a method for producing light guide plates having light-influencing structures, characterized in that
a plastic web is produced,
a device for smoothing the surface of the plastic plate web is used during extrusion,
the plastic web is led past continuously below and/or above at least one laser engraving device,
by means of the laser engraving device, light-influencing structures are engraved into at least one surface of the plastic web and/or are produced by laser internal engraving in the interior of the plastic web,
individual light guide plates are produced from the structured plastic web obtained.

The invention furthermore relates to an apparatus for producing light guide plates having light-influencing structures, characterized in that
it comprises a device for producing a plastic web, preferably at least one extruder,
it comprises a device for smoothing the surface of the plastic plate web during extrusion,
it comprises a device for continuously transporting the plastic web,
it is configured in such a way that the plastic web is led past continuously below and/or above at least one laser engraving device, and
it comprises a plastic web separating device.

The present invention is described in detail below.

The terms plastic web, plate web, plastic plate web and web are used synonymously in the context of the present invention. The terms plastic plates, light guiding plates, light guide plates and plate and the terms plastic web separating device and separating device are likewise used synonymously. The terms laser engraver and laser engraving device are likewise synonymous.

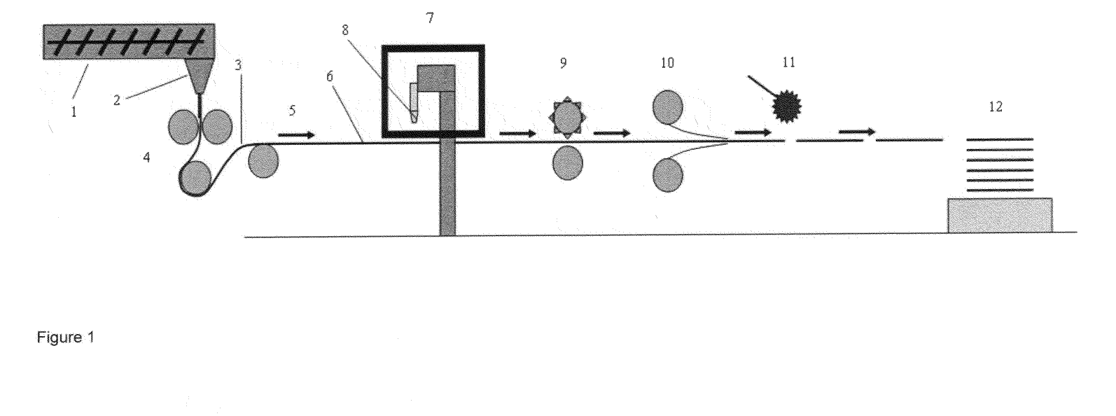

The method of the present invention is distinguished by the fact that a laser engraving device is integrated into a continuous light guide plate production apparatus, preferably a plastic plate extrusion line. Particularly preferably, the laser engraving device is in this case fitted between the so-called polishing stack and the separating device of the plastic extrusion line either above and/or below the cooling plastic web (see FIG. 1 for an example with a laser engraving device fitted above the plastic web).

By virtue of the integration of the laser engraving device into the continuous plastic plate extrusion line, patterns of light-influencing cavities can be introduced into at least one or simultaneously into both surfaces of the cooling plastic plate web already during the production of the plastic plates in the feed movement of the plate web. After complete cooling of the plastic web, the light guide plates bearing the pattern of light-influencing cavities can be cut out from the plastic web.

The inventors have discovered that, in order to ensure sufficient total internal reflection, it is important for the light guides to have surfaces that are as planar as possible. In order to ensure this, the apparatuses according to the invention comprise a polishing stack, or a polishing stack is used in the method according to the invention. This has the effect of obtaining light guiding plates having low surface roughness on both sides.

The inventors have discovered that particularly advantageous light guides are obtained if the surface roughness of the light guide, measured according to DIN EN ISO 4287, is less than 1 mm, particularly preferably less than 500 nm, very particularly preferably less than 400, especially preferably less than 350 nm, very especially preferably less than 300 nm and in particular preferably less than 250 nm. The choice of corresponding polishing stacks and the operation thereof for achieving corresponding surface roughnesses are possible by a person skilled in the art using said person's common general knowledge in the art.

Polishing stacks having 2, 3, 4 or even more rolls can be used for the preferred light guide material poly(methyl) methacrylate-based plastics. In this case, the temperatures of the rolls are chosen preferably in a range of 70 to 130° C., particularly preferably 80 to 120° C. and very particularly preferably 85 to 115° C. Preferably, all rolls are operated in this temperature range. However, it is also possible to operate individual or a plurality of rolls in different temperature ranges.

The speed of the rolls can preferably be chosen in the range of 0.5 to 5 m/min.

By means of the distance between the laser engraving device and the polishing stack and/or the feed rate of the web, it is possible in this case to control the temperature of the plastic plate web at which the laser engraving is effected. At higher temperature, larger cavities, which bring about greater light influencing, can be engraved with the same laser power. To engrave cavities of the same size, a lower laser power is sufficient at higher temperature. In one preferred embodiment of the method according to the invention and of the apparatus according to the invention, respectively, therefore, the distance between the polishing stack and the laser unit and/or the feed rate are/is chosen such that the plate web is cooled to the corresponding temperature at which the laser structuring is intended to take place. In this case, the temperature of the web and the laser power are adapted such that cavities having a desired geometry (for example depth) arise.

In one particularly preferred embodiment, the geometry of the cavities is determined by the feed direction of the plate web in the x-direction and the movement of the laser heads in the y-direction, i.e. the direction transversely with respect to the feed direction of the plate web. In this case, the extrusion rate or the feed rate is coupled to the laser speed.

Since the pattern of the cavities and the exact geometry and arrangement of each individual cavity are dependent, inter alia, on the dimensions of the light guide plate (thickness, height), and on the plastic used for the light guide plate, the exact mode of operation of the apparatus according to the invention and of the method according to the invention, respectively, has to be defined individually in each case, and the parameters of laser power, distance between laser head and/or the oscillatory mirror and the surface, facing the latter, of the plastic web, thickness of the plastic web, temperature of the plastic web, position of the laser engraving unit and extrusion rate or the plate feed rate have to be adapted individually in each case. The apparatus used according to the invention is correspondingly configured in order to be able to ensure individual control of the parameters mentioned. Furthermore, it is provided with corresponding computer-controlled closed-loop control, open-loop control and monitoring units.

In one preferred embodiment, the feed rate of the plastic web to be engraved can be varied between 0.5 and 10 m/min, particularly preferably between 1 and 6 m/min, very particularly preferably between 2 and 4 m/min.

The cavities in the surface of the light guide plate preferably have a depth range of between 40-1000 μm, particularly preferably 60 and 500 μm, very particularly preferably 100 and 300 μm and a half-value diameter (definition: diameter for which the cavity depth is half of the maximum centre value) of between 50-500 μm, particularly preferably 60 and 250 μm, very particularly preferably 80 and 150 μm.

The lasers preferably used are CO2, excimer, HeNe lasers, N2 lasers, and others. The laser power per end beam impinging on the surface of the plate is between 2 W and 400 W, preferably 5 W and 150 W.

The temperature of the surface, facing the active laser engraving device, of the plastic web is preferably in the range of 25 to 120° C., particularly preferably of 40 to 100° C. and very particularly preferably 60 to 100° C. However, it can be adapted depending on the polymer used.

The inventors have discovered that a higher temperature of the plastic plate web has a positive effect on stress corrosion. Without being bound to a specific theory, the inventors are of the view that during the laser engraving of plastics, plastic molecules are broken up and evaporated in order thus to produce a cavity. The gases arising in this case can diffuse into the remaining plastic and, particularly in the case of PMMA, a plastic preferably used for light guide plates, produce stress corrosion. This can lead to stress cracks. As a result of laser engraving at an elevated temperature of the plastic plate web, the stresses can be reduced and stress cracks in the plate can thus be avoided. In one particularly preferred embodiment, therefore, the temperature of the surface, facing the active laser engraving unit, of the plastic web in the case of a plastic based on polymethyl methacrylate (PMMA) is 40 to 120° C., very particularly preferably 60 to 100° C. In this case, active laser engraving device is understood to mean the laser engraving device whose laser is activated during the passage of the plastic web. Although the apparatus according to the invention can be configured in such a way that both surfaces of the plastic web can be engraved, it is possible that the apparatus is operated in such a way that only one side is engraved. The laser situated on this side is then designated as “active” and the laser situated on the other side is designated as “passive”. If such an apparatus is operated only with one laser, but the beams are optically split accordingly, the “laser-active” and “laser-passive” sides are thereby defined.

The laser engraving device is computer-controlled such that it is possible to change over from one pattern of light-influencing cavities to another pattern very flexibly during ongoing extrusion operation. For this purpose, the laser engraving device can preferably be moved transversely (Y-direction) and/or parallel (X-direction) and/or at a distance with respect to the surface of the plastic web (Z-direction). Either the entire apparatus or else only some parts, such as e.g. the heads or mirrors, can be moved. High flexibility and diversity are thereby ensured.

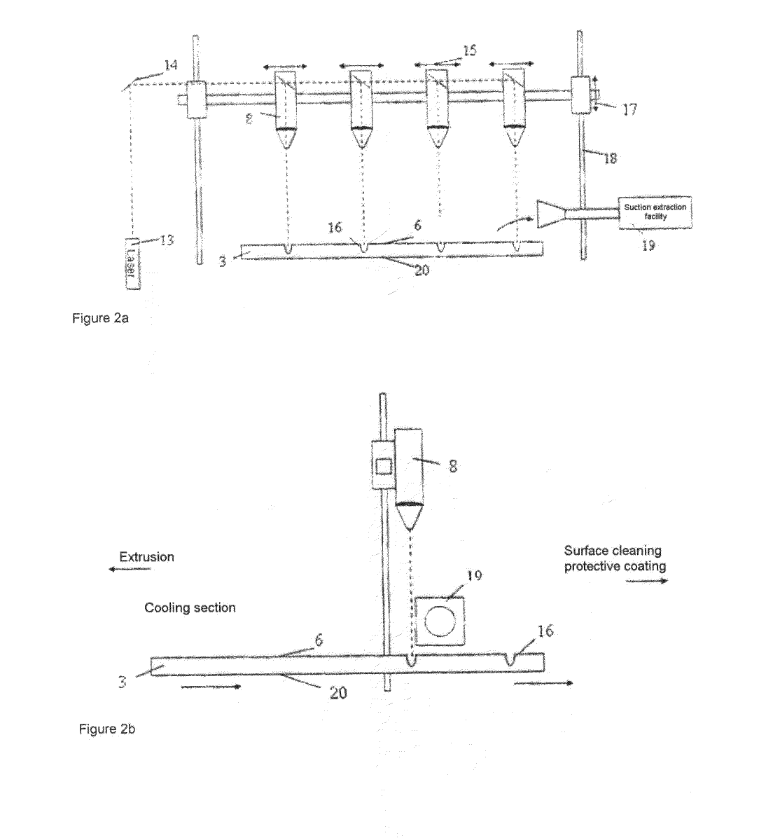

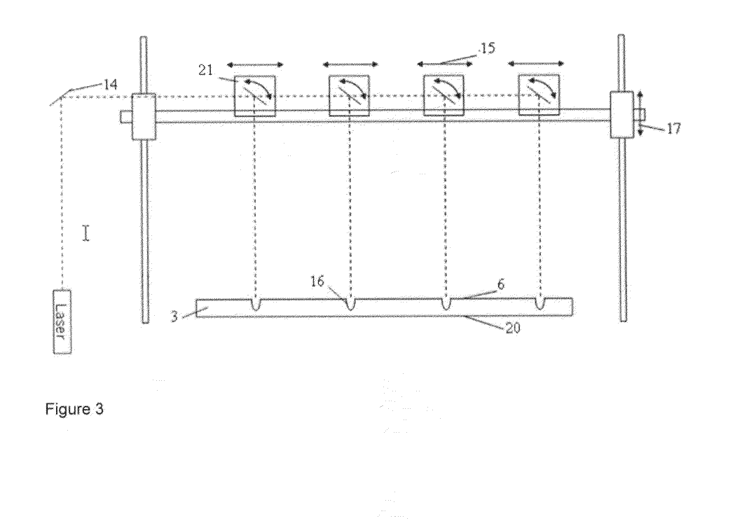

In the method according to the invention, the laser beam is preferably generated by one or a plurality of lasers. In one particularly preferred embodiment, the beam or the beams is/are split into further beams that can be used separately for structuring, and thus increase the processing speed. The beam guiding and splitting can in this case be controlled by corresponding optical elements, such as e.g. semi-transparent mirrors. All of the beams generated finally impinge on different locations of the surface of the plate and produce cavities having a defined geometry there. In the last section of the beam path, according to the invention, preferably one or a plurality of laser head/laser heads having a lens (see, for example, FIGS. 2a and 2b) and/or one or a plurality of, preferably oscillatory, mirrors, in particular a galvo head (see, for example, FIG. 3), is/are used to focus the respective laser beam. The head or the heads is/are fixed above the plate web of the continuous extrusion apparatus. The distance between laser head and plate surface (Z-direction) is preferably adjustable. Furthermore, the heads can be moved transversely (Y-direction) and/or parallel (X-direction), particularly preferably transversely, with respect to the plate feed direction, in order to be able to scan a larger plate region. In these particularly preferred embodiments, it is possible to solve the challenges of applying structures on a moving plate and simultaneously ensuring that the previously calculated structure pattern is reproduced on the surface of the plate reproducibly and with high quality and is not altered by the movement of the plate. In this case, the method according to the invention allows the structure pattern to be altered in a simple and inexpensive manner, and thus to be adapted to the corresponding light guide plate geometry and structure size. Furthermore, the structuring rate can be adapted to the feed rate of the plate extrusion apparatus, and a limitation of the output of the plate extrusion apparatus by the structuring process can thus be avoided. The method according to the invention thus allows continuous and cost-effective production of light guide plates.

The apparatus used in the method according to the invention preferably comprises a device for removing the gases arising during laser engraving, particularly preferably a suction device. Corresponding technical solutions are known to the person skilled in the art. There are no specific restrictions in this regard. The method according to the invention and the apparatus according to the invention thus make it possible to eliminate by-products harmful to health in a simple manner, without using complex and expensive protective measures. If the plastic is a plastic based on PMMA, then the arising gas is principally MMA, which, in one specific variant of the method according to the invention, is captured and reused for preparing PMMA.

After laser engraving, in further process steps of the method according to the invention, in a continuous manner, the plate is, if appropriate, cleaned, given a protective coating and subsequently cut to size. The apparatus according to the invention is configured accordingly.

The plastic web used in the method according to the invention preferably comprises at least one or a plurality of transparent thermoplastic plastic(s); particularly preferably, a plastic containing PMMA, polycarbonate, polystyrene, cyclo-olefin copolymers, PET, PMMI (polymethyl methacrylimide), polysulfone is involved. Very particularly preferably, a plastic containing PMMA is involved.

In one specific embodiment, the plastic web additionally comprises scattering particles, preferably TiO2, BaSO4, polystyrene- or polysilsesquioxane-based systems.

The thickness of the plastic web used according to the invention is preferably in the range of 0.5 to 25 mm, particularly preferably of 1 to 20 mm and very particularly preferably of 2 to 10 mm.

The following examples serve to provide a more detailed explanation and to afford a better understanding of the present invention, but do not restrict the latter in any way.

### EXAMPLES

### Example 1

As Example 1, an apparatus according to the invention comprising a laser engraving device having laser heads is shown in FIGS. 1, 2a and 2b.

FIG. 1 shows one preferred embodiment of the apparatus according to the invention. From a transparent moulding compound, a plastic web (3) is extruded by means of a single-screw extruder (1) and a die (2) and is guided via the polishing stack (4). The cooling section (5) is configured in such a way that the surface (6) to be structured of the plastic web (3), said surface facing the active laser engraving device (7), below the laser head (8) has the desired temperature. After the engraving of the plastic web (3), the surface thereof is cleaned in the unit (9), a protective coating is applied (10), the plates are cut to size (11) and palletized (12).

A comparison of two cavities which were engraved with the same laser power but at different temperatures of the plastic web showed that increasing the temperature of the plastic web by 70° C. led to a cavity deeper by 12%.

FIGS. 2a, 2b and 3 in each case show an enlarged excerpt from the region of the apparatus according to the invention at which the laser engraving device (7) is situated.

In FIG. 2a, the laser engraving device (7) comprises a laser (13), a deflection mirror (14) and a plurality of laser heads (8), which can be moved both in the Y-direction (15), i.e. transversely with respect to the feed direction of the plate web, and in the Z-direction (17) (distance between the laser head and the surface of the plate web) with respect to the direction of movement of the plastic web (X-direction). The laser heads (8) are movably attached to the holding device (18). With the aid of the laser beam split among the various laser heads, a plurality of cavities (16) are simultaneously engraved into the surface (6) facing the laser engraving device (7). The surface (20) facing away from the laser engraving device (7) is not structured in this example. In order to remove the gases arising during engraving, the apparatus comprises a suction extraction facility (19).

FIG. 2b illustrates a view of FIG. 2a rotated by 90°.

### Example 2

As Example 2, an apparatus according to the invention comprising a laser engraving device having galvo heads is shown in FIGS. 1 and 3.

FIG. 3 differs from FIG. 2a in that galvo heads (21) are used instead of laser heads (8). Said galvo heads can also be moved correspondingly in the Y-direction (15) and Z-direction (17).

### Example 3

The effect of the temperature variation of the plastic web on the cavities is shown in Example 3.

For laser structuring, in this case use was made of a Eurolaser M1200 table, equipped with an x-y movable engraving optical head. The distance between the head and the plate surface facing the latter was set manually, thus resulting in a distance of 60 mm between the 2.5″ lens and the plate surface. The x-y laser head position above the plate was computer-controlled. The laser structures were engraved on the plate.

Continuously extruded plates of the acrylic moulding compound PLEXIGLAS® POQ66, which has a particularly high optical purity, were selected for laser engraving. Plates were laser-structured at temperatures of 20° C. and 90° C., with a laser power of 100 W. The resulting cavities in the plate surface were determined from sectional images by means of a scanning electron microscope (SEM). It can be discerned from the SEM images that deeper cavities arise at a higher working temperature. The depth difference between the two temperatures was approximately 90 μm, which corresponds to approximately 12%.

In order to test the stress-cracking resistance, the plates were immersed in ethylester. The plates laser-structured at 20° C. exhibited a plurality of clearly visible cracks after an immersion time of just 30 sec. The plates laser-structured at 90° C. exhibited no cracks even after an immersion time of 8 min. This shows that inline laser structuring at an elevated temperature leads to both improved stress cracking resistance and chemical resistance.

### Example 4

The continuous laser structuring of a PMMA-based light guide is shown in Example 4.

For this example, the Eurolaser M1200 laser was used with the same parameters as in Example 3. For moving the laser head, the movement was restricted to the y-axis, wherein the structuring was effected only in one direction (“outgoing” movement). A light guide plate having a width of 250 mm was moved below the moving laser head along the x-axis at a speed of 0.32 m/min. The speed of the laser was 1 m/sec. Consequently, line spacings of 5 mm arose on the surface of the plate. In this case, the outgoing and return travel of the laser head including a rest pause of 0.5 s should be taken into consideration. The coupling-out of light from the resulting light guide plate was determined by means of a luminance CCD camera. In this case, the light was coupled in via the two short sides with the aid of LEDs. The luminance image obtained showed the brightness distribution for the laser-structured light guide. A specific luminance is assigned to each grey shade, brighter shades signifying higher luminance values. In the present case, it was found that the brightness distribution over the plate is relatively homogeneous, that is to say that a corresponding amount of light is also coupled out from the centre of the plate. This shows that the continuous production of the light guide plate was carried out successfully and the pattern could be produced sufficiently precisely.

### Example 5

The influence of the polishing stack on the surface roughness of extruded PMMA-based light guides is shown.

For this example, light guiding plates were extruded with and without a polishing stack and the surface roughness was determined. For this purpose, a 4-roll polishing stack was used. The process parameters of the rolls of the polishing stack for the plate thickness of 1.5 to 6 mm are as follows:

### Temperature:

roll 1: 85 to 92° C.
roll 2: 94 to 100° C.
roll 3: 102 to 112° C.
roll 4: 105 to 113° C.

### Speed:

Master speed roll 2: 1.0 to 3.6 m/min
The speeds of rolls 1, 3 and 4 are moved more slowly by up to 1.5% relative to the master speed of roll 2.

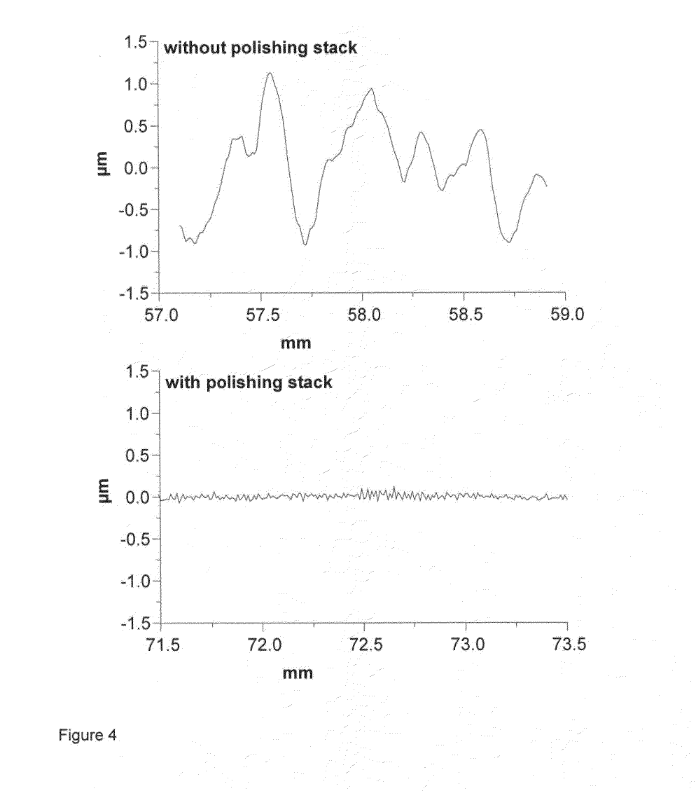

The primary profile characteristic variable of the surface roughness was determined according to DIN EN ISO 4287. The surface profiles determined can be seen in FIG. 4. The light guiding plate extruded without a polishing stack has a significantly higher surface roughness than the plate with a polishing stack. The total height of the profile Pt is 2.07 μm for the plate without a polishing stack and 0.24 μm with a polishing stack.

The light guide plates were engraved according to the invention. Application-related tests revealed that the light guide plates according to the invention had outstanding light coupling-out properties, whereas the plates without smoothing did not exhibit adequate performance.

### LIST OF REFERENCE SIGNS

1: Single-screw extruder
2: Die
3: Plastic web
4: Polishing stack
5: Cooling section
6: Surface of the plastic web (3) facing the active laser engraving unit
7: Laser engraving device
8: Laser head
9: Cleaning unit
10: Unit for applying the protective coating
11: Plate separating device
12: Palletization
13: Laser
14: Deflection mirror
15: Y-direction
16: Cavity
17: Z-direction
18: Holding device
19: Suction extraction facility
20: Surface of the plastic web (3) facing away from the active laser engraving unit
21: Galvo heads

1. A method for producing a light guide plate having light-influencing structures, the method comprising:
producing a plastic web by extrusion, in the presence of a device for smoothing the surface of a plastic plate web;
continuously passing the plastic web below and/or above at least one laser engraving device;
laser engraving light-influencing structures into at least one surface of the plastic web and/or in the interior of the plastic web with a laser engraving device, to obtain a structured plastic web; and
producing individual light guide plates from the structured plastic web,
wherein the laser engraving device is arranged into a continuous extrusion apparatus downstream of an extrusion polishing stack such that the laser engraving occurs at a temperature of the surface of the plastic web, facing the laser engraving device, of 40 to 120° C.

2. The method according to claim 1, wherein:
the laser engraving device is integrated into the continuous extrusion apparatus between the extrusion polishing stack and a plastic web separating device; and/or
a feed rate of the plastic web to be engraved is between 0.5 and 10 m/min.

3. The method of claim 1, wherein:
at least one laser beam is generated by at least one laser; and/or
the at least one laser beam is split into further beams which separately structure the plastic web; and/or
the at least one laser beam is guided by at least one laser head comprising a lens, at least one oscillatory mirror, or both.

4. The method according to claim 3, wherein at least one of the laser engraving device, the at least one laser head, and the at least one oscillatory mirror are moved parallel, transversely, or both, with respect to a feed direction of the plastic web and/or their distance from the surface of the plastic web is varied.

5. The method of claim 1, wherein by adapting the temperature of the surface, facing the laser engraving device, of the plastic web and/or the laser power, the geometry of the cavities is controlled, and/or the geometry of the cavities is controlled by adjusting the distance between a laser head and/or a mirror and the surface, facing the latter, of the plastic web.

6. The method of claim 1, wherein:
the plastic web comprises
at least one transparent thermoplastic plastic, and/or
at least one transparent thermoplastic plastic comprising scattering particles; and/or
the plastic web has a thickness in the range of 0.5 to 25 mm.

7. The method of claim 1, wherein:
a laser of the laser engraving device is a CO2 laser, an excimer laser, a HeNe laser, or a N2 laser; and/or
the laser power per beam is controlled in the range between 2 W and 400 W.

8. The method of claim 1, wherein surface engraving occurs on both sides of the plastic web.

9. The method of claim 1, wherein the laser engraving occurs at a temperature of the surface of the plastic web, facing the laser engraving device, of 60 to 100° C.

10. The method of claim 2, wherein the feed rate of the plastic web to be engraved is between 2 and 4 m/min.

11. The method of claim 2, wherein:
at least one laser beam is generated by at least one laser; and/or
the at least one laser beam is split into further beams which separately structure the plastic web; and/or
the at least one laser beam is guided by at least one laser head comprising a lens, at least one oscillatory mirror, or both.

12. The method of claim 6, wherein the plastic web comprises at least one transparent thermoplastic plastic comprising PMMA or a polycarbonate.

13. The method of claim 6, wherein the plastic web has a thickness in the range of 2 to 10 mm.

14. The method of claim 7, wherein the laser power beam is controlled in the range between 5 W and 150 W.
